(19) United States
(12) Patent Application Publication
(10) Pub. No.: US 2016/0252038 A1
(43) Pub. Date: Sep. 1, 2016

(54) Device and method for reducing variants in fuel pump electronics

(71) Applicant: CONTINENTAL AUTOMOTIVE GMBH, Hannover (DE)

(72) Inventor: Gerald BEHRENDT, Frankfurt am Main (DE)

(21) Appl. No.: 15/028,327

(22) PCT Filed: Oct. 9, 2014
(86) PCT No.: PCT/EP2014/071688

§ 371 Date: Apr. 8, 2016

(30) Foreign Application Priority Data
Oct. 11, 2013 (DE) 10 2013 220 607.0

(51) Int. Cl. F02D 41/30; F02D 41/24

(52) U.S. Cl. CPC F02D 41/3082; F02D 41/2422

(57) ABSTRACT

A system for fuel pump control includes: fuel delivery electronics configured to control different fuel pumps, the fuel delivery electronics being operated, at least in part, based on a control frequency; and a multiplicity of datasets, each dataset of the multiplicity of datasets being configured to control a respective different fuel pump. The fuel delivery electronics are configured such that, depending on the control frequency with which the fuel delivery electronics are operated, the fuel delivery electronics utilize a predetermined dataset from the multiplicity of datasets to control the respective fuel pump.

### CROSS-REFERENCE TO RELATED APPLICATIONS

This is a U.S. national stage of application No. PCT/EP2014/071688, filed on 09 Oct. 2014, which claims priority to the German Application No. 10 2013 220 607.0 filed 11 Oct. 2013, the content of both incorporated herein by reference.

### BACKGROUND OF THE INVENTION

1. Field of the Invention

The present invention relates to fuel pumps, and specifically to fuel pump electronics.

2. Related Art

It is known that vehicles that use different fuel types, for example diesel and gasoline, exist. In the case of such different fuels, or even in the case of different engine configurations, it is possible for a different fuel delivery unit to be installed in the tank. In the case of diesel, a gerotor pump may be used. In the case of gasoline, a pump with a turbine may be used. In the case of a relatively high-performance gasoline variant, it is possible for a yet further different fuel pump to be used.

It is normally the case in this situation that multiple different parting lines and other characteristics are required in the set of fuel delivery electronics. Different parameterization necessitates different equipment variants, because the software versions differ from one another. It is self-evidently possible for the characteristics to be realized by way of equipment datasets that are then set to the specific variant during construction of the vehicle. However, this involves programming outlay and logistical outlay, which is not always desirable. For example, write access to the equipment is necessary in order to change the coding.

### SUMMARY OF THE INVENTION

It is an object of the invention to eliminate or at least reduce the problems that arise in conjunction with the known sets of fuel delivery electronics.

In general, a set of fuel delivery electronics for a fuel pump according to a first aspect of the invention has a multiplicity of datasets for the control of different fuel pumps. The set of fuel delivery electronics is configured such that, in a manner dependent on the control frequency with which the set of fuel delivery electronics is operated, the set of fuel delivery electronics utilizes a predetermined dataset from the multiplicity of datasets.

In one embodiment, the control frequency may be applied with a deviation in the range of +/−5%.

In a further embodiment, the set of fuel delivery electronics may also be configured to determine the control frequency within the first five seconds after an activation.

In one embodiment, the multiplicity of datasets may have a dataset that can be utilized in the case of a diesel pump. The dataset may for example be utilized if the control frequency is 100 Hz.

In another embodiment, the multiplicity of datasets may have a dataset that can be utilized in the case of a gasoline pump.

The dataset may be utilized for example if the control frequency is 150 Hz or 200 Hz.

Other control frequencies may also be provided. It is crucial that the different control frequencies can be reliably distinguished from one another. On the basis of the applied control frequency, the hardware decides which dataset, that is to say which parameters, are utilized.

Since the frequency is predefined by the engine control unit, which correlates with the motor configuration used, it is now possible for a multiplicity of control unit variants to be covered with one set of electronics.

According to a second aspect of the invention, a set of fuel delivery electronics for a fuel pump has a multiplicity of datasets for the control of different fuel pumps, wherein the set of fuel delivery electronics is configured such that, in a manner dependent on a control signal, the set of fuel delivery electronics utilizes a predetermined dataset from the multiplicity of datasets in order to control the fuel pump.

In general, a method according to an aspect of the invention for the configuration of a set of fuel delivery electronics includes: detecting a control frequency with which the set of fuel delivery electronics is operated, and selecting a dataset for the control of a specific fuel pump from a multiplicity of datasets in a manner dependent on the control frequency.

Alternatively, the method for the configuration of a set of fuel delivery electronics may include: detecting a control signal, and selecting a dataset for the control of a specific fuel pump from a multiplicity of datasets in a manner dependent on the control signal.

In one embodiment, the method may be executed in the first five seconds after an activation of the fuel delivery electronics. In such time, it is possible for a “default” dataset to be implemented and for a pump to be operated on the basis thereof.

Owing to the nature of the method according to aspects of the invention, it is possible for a computer program to be provided that carries out all of the steps of a method if it is executed on a set of fuel delivery electronics as described above. A corresponding computer program may be loaded into a working memory (for example a flash memory) of a control unit. The control unit or a data processor is thus equipped to execute the method according to the invention.

In particular, the selected dataset including the parameters for the actuation of the fuel pump may be utilized by way of the computer program. For example, the parameters for single-step control, or a rotational speed and/or a duration, may be defined.

It is correspondingly also possible for a computer-readable medium such as a CD-ROM or a flash drive to be provided, in which the computer program can be stored. However, the computer program may likewise be provided via a network such as the Internet, and may be downloaded from the network into the working memory of the control unit.

It is pointed out that embodiments of the invention will be described with reference to different subjects. In particular, some embodiments are described with reference to device claims and other embodiments are described with reference to method claims. However, from the description above and below, a person skilled in the art will likewise, in addition to every combination of features belonging to one type of subject, identify every combination between features described with reference to different subjects. These all form part of the overall disclosure of the application.

### BRIEF DESCRIPTION OF THE DRAWINGS

Aspects described above, and further aspects, features and advantages of the invention, may likewise emerge from the examples of embodiments described below with reference to the appended drawings. It is pointed out that the invention is not restricted to said embodiments. In the drawings:

FIG. 1 is a schematic illustration of a system according to the invention; and

FIG. 2 is a flow diagram for schematically illustrating a method according to the invention.

### DETAILED DESCRIPTION OF THE PRESENTLY PREFERRED EMBODIMENTS

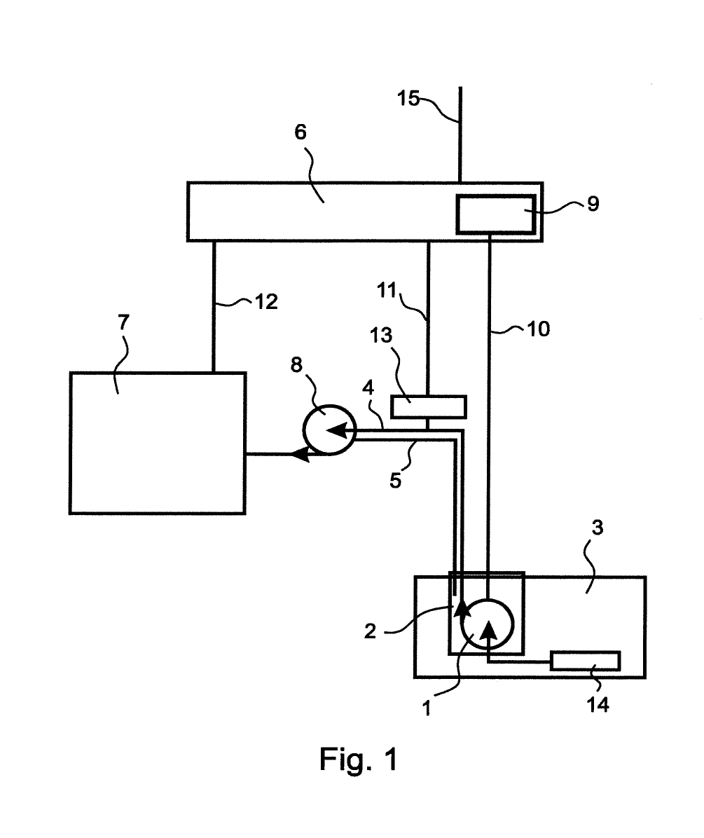

It is pointed out that, below, embodiments will be described in detail, which embodiments are merely illustrative and are not of a restrictive nature. FIG. 1 schematically illustrates a system, wherein the system has a fuel pump 1 in a fuel delivery unit 2 provided in a tank 3, wherein a pump intake filter 14 is positioned upstream of the fuel pump 1. In one embodiment, the fuel pump may be a gerotor pump, whereby it can be used as a diesel pump. Alternatively, the fuel pump may be a turbine-type pump, whereby it can be used as a gasoline pump.

Via the fuel line 4, the fuel is delivered out of the tank 3 to a high-pressure pump 8, which increases the pressure of the fuel and conveys the fuel at high pressure into an internal combustion engine 7. It is pointed out that the pressure in the fuel line 4 may be approximately 8 bar, whereas the high pressure at the internal combustion engine may be several hundred bar.

On the fuel line 4 there is provided a pressure sensor 13 for monitoring the pressure in the fuel line 4. Via the sensor line 11, a signal is transmitted from the pressure sensor 13 to a control unit 6. The set of fuel delivery electronics 9, which in this embodiment is integrated into the control unit 6, controls the fuel pump 1 via the pump control line 10.

Furthermore, the control unit 6 is connected to the internal combustion engine 7 via the motor control line 12. In this way, it is possible for parameters of the motor to be taken into consideration in the control of the fuel pump.

Alternatively, the control unit 6 may be constructed from multiple separate units, wherein the units may be interlinked with one another.

By way of a fuel return line 5, it is possible for excess delivered fuel to be conducted back to the delivery unit 2 from the high-pressure pump 8.

The control unit 6 is connected via an energy supply line 15 to an energy source (not illustrated).

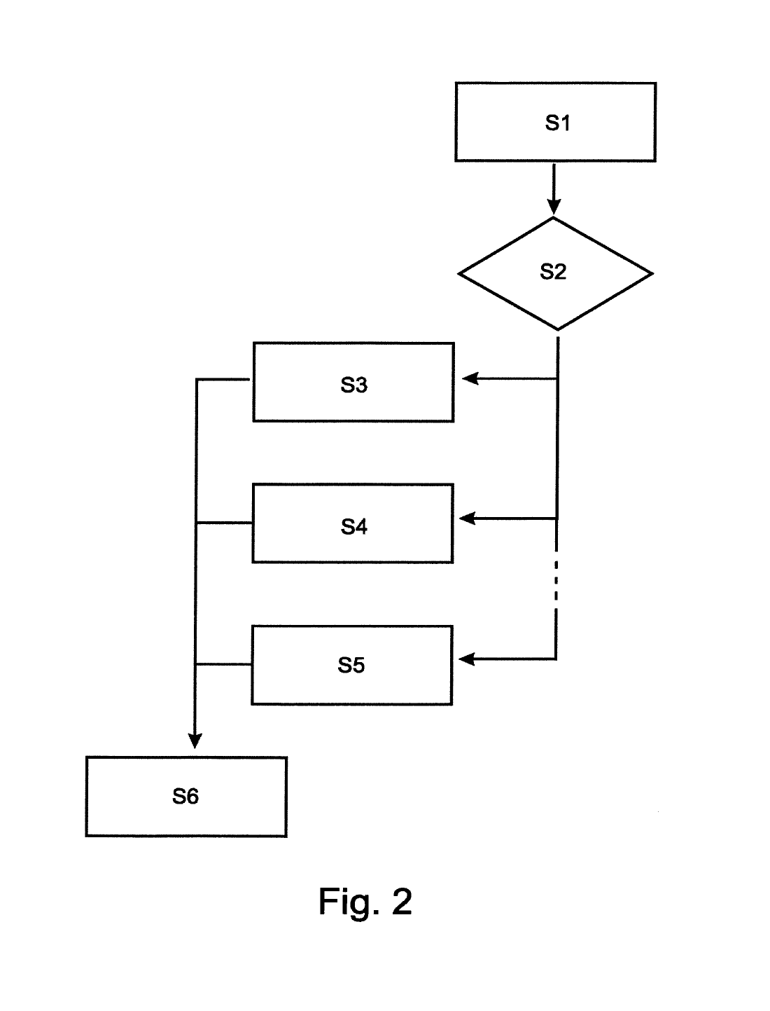

FIG. 2 is a flow diagram that shows, in principle, the steps of a method for the configuration of a set of fuel delivery electronics. The described steps are main steps, wherein the main steps may be differentiated and subdivided into sub-steps. Furthermore, further sub-steps may be provided between the main steps. Therefore, a sub-step is referred to only when the step is important for understanding the principle of the method according to the invention.

Step S1 denotes the start of a method according to the invention. Here, the set of fuel delivery electronics, and the engine control unit, are activated.

In step S2, the control frequency with which the engine control unit activates the set of fuel delivery electronics is determined by the fuel delivery electronics, such that a specific dataset can be selected for the control of the associated fuel pump.

The steps S3, S4 and S5 represent steps which may be carried out alternatively, wherein the steps differ merely by the fact that a different dataset is activated. For example, in step S3, a dataset with parameters for the control of a diesel pump may be activated. Steps S4 and S5 include datasets for the control of a gasoline pump, wherein the pumps themselves may differ with regard to their performance characteristics. The dashed section of the line between S2 and S5 is intended to indicate that there may be not only three but more datasets for different pumps, which could then logically also be listed as alternative steps. After a dataset has been activated, this is utilized in step S6 for the control of a fuel pump.

Whereas the invention has been illustrated and described in detail in the drawings and in the preceding description, such illustrations and descriptions are to be regarded merely as illustrative or exemplary, and not as restrictive. The invention is not restricted to the disclosed embodiments. Other variations of the disclosed embodiments may be understood and implemented by a person skilled in the art in executing the claimed invention having studied the drawings, the disclosure and the appended claims. In the claims, the word “have” does not rule out other elements or steps, and the indefinite article “a” does not rule out a multiplicity.

The fact that individual features are specified in different dependent claims is not intended to signify that a combination of the features cannot be used to advantageous effect. The reference designations in the claims are not intended to restrict the scope of the claims.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

### LIST OF REFERENCE NUMERALS

1 Fuel pump
2 Delivery unit
3 Tank
4 Fuel line
5 Fuel return line
6 Control unit
7 Combustion engine
8 High-pressure pump
9 Set of fuel delivery electronics
10 Pump control line
11 Sensor line
12 Motor control line
13 Pressure sensor
14 Pump intake filter
15 Energy supply line

1-10. (canceled)

11. A system for fuel pump control, comprising:
fuel delivery electronics (9) configured to control different fuel pumps, the fuel delivery electronics (9) being operated, at least in part, based on a control frequency; and
a multiplicity of datasets, each dataset of the multiplicity of datasets being configured to control a respective different fuel pump,
wherein the fuel delivery electronics (9) are configured such that, depending on the control frequency with which the fuel delivery electronics are operated, said fuel delivery electronics utilize a predetermined dataset from the multiplicity of datasets to control the respective fuel pump.

12. The system as claimed in claim 11, wherein the control frequency is applied with a deviation in the range of +/−5%.

13. The system as claimed in claim 11, wherein the fuel delivery electronics are configured to determine the control frequency within the first five seconds after activation of the fuel delivery electronics.

14. The system as claimed in claim 11, wherein the multiplicity of datasets includes a dataset utilizable in the case of a diesel pump, and wherein the dataset for the diesel pump is utilized if the control frequency is 100 Hz.

15. The system as claimed in claim 11, wherein the multiplicity of datasets includes a dataset utilizable in the case of a gasoline pump, and wherein the dataset for the gasoline pump is utilized if the control frequency is 150 Hz or 200 Hz.

16. A system for fuel pump control, comprising:
fuel delivery electronics (9) configured to control different fuel pumps, the fuel delivery electronics (9) being operated, at least in part, based on a control signal; and
a multiplicity of datasets, each dataset of the multiplicity of datasets being configured to control a respective different fuel pump,
wherein the fuel delivery electronics (9) are configured such that, depending on the control signal, said fuel delivery electronics utilize a predetermined dataset from the multiplicity of datasets to control the respective fuel pump.

17. The system as claimed in claim 16, wherein the multiplicity of datasets has at least one dataset for the control of a diesel pump and at least one dataset for the control of a gasoline pump.

18. A method for the configuration of the fuel delivery electronics (9) as claimed in claim 11, including:
detecting the control frequency with which fuel delivery electronics are operated, and
selecting a dataset for the control of a specific fuel pump (1) from the multiplicity of datasets based on the detected control frequency.

19. The method for the configuration of fuel delivery electronics (9) as claimed in claim 16, including:
detecting the control signal, and
selecting a dataset for the control of a specific fuel pump (1) from the multiplicity of datasets based on the detected control signal.

20. The method as claimed in claims 18, wherein the method is executed in the first five seconds after an activation of the set of fuel delivery electronics (9).

21. The system as claimed in claim 11, wherein the multiplicity of datasets has at least one dataset for the control of a diesel pump and at least one dataset for the control of a gasoline pump.

22. The method as claimed in claim 19, wherein the method is executed in the first five seconds after an activation of the set of fuel delivery electronics (9).
